(19) United States
(12) Patent Application Publication
(10) Pub. No.: US 2008/0186866 A1
(43) Pub. Date: Aug. 7, 2008

(54) COMMUNICATION-QUALITY MEASURING APPARATUS, COMMUNICATION-QUALITY MEASURING METHOD, AND COMPUTER PROGRAM

(75) Inventors: Masanobu Morinaga, Kawasaki (JP); Noriyuki Fukuyama, Kawasaki (JP); Hideaki Miyazaki, Kawasaki (JP); Sumiyo Okada, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/024,544

(22) Filed: Feb. 1, 2008

(30) Foreign Application Priority Data
Feb. 5, 2007 (JP) 2007-026091

(51) Int. Cl. H04L 12/24

(52) U.S. Cl. 370/247

(57) ABSTRACT

A communication quality measuring apparatus comprising a connecting section establishing a connection to the packet exchange network, a capturing section capturing packets transferred over the packet exchange network, an accumulating section accumulating the packets, a control section repeating the capturing of packets in sections of fundamental processing times, a setting section setting the capturing time and the interval time within each fundamental processing time, and a determining section determining whether or not the amount of load on hardware resources of the communication-quality measuring apparatus is greater than a predetermined value.

### CROSS-REFERENCE TO RELATED APPLICATIONS

This application is related to and claims priority to Japanese patent application no. 2007-26091 filed on Feb. 5.2007 in the Japan Patent Office, and incorporated by reference herein.

### BACKGROUND OF THE INVENTION

1. Field of the Invention

The present invention relates to communication-quality measuring apparatuses, communication-quality measuring methods, and computer programs for capturing packets transferred over a packet exchange network, analyzing the packets captured, and measuring quality, such as loss or delay of the packets, in the packet exchange network. More particularly, the present invention relates to a communication-quality measuring apparatus, a communication-quality measuring method, and a computer program allowing a computer to function as a communication-quality measuring apparatus that can measure communication quality in accordance with load on hardware resources of the apparatus even in the case where the apparatus is an inexpensive apparatus. The computer program may be recorded, for example, on a recording medium, or on another type of fixed or portable memory.

2. Description of the Related Art

As information technologies have been developed, bi-directional communication over a packet exchange network has been actively performed. In particular, Internet protocol (IP) phones using the Voice over Internet Protocol (VoIP) function enabling a voice call via the Internet by transmitting and receiving packetized voice data over the packet exchange network have become widely used.

The human sense of hearing is sensitive to noise and interruption in sound. For this reason, a loss of a voice packet in the packet exchange network has a significant influence on the quality of IP phones. The IP phones therefore impose a high demand on the quality of service (QoS) ensuring function.

Various proposals have been made for technologies for communication-quality measuring methods of measuring a loss, delay, jitter, or the like of packets transferred over a packet exchange network for providing IP phone service. Generally in the related art, the quality is measured by capturing all the packets transmitted to the packet exchange network, analyzing headers of the packets including descriptions of the sequence of the packets and time, and detecting any loss and/or delay of the packets. Japanese Unexamined Patent Application Publication No. 2005-236909 discloses the technique of periodically transmitting test packets to a packet exchange network and measuring communication quality by determining whether or not all the packets transmitted have been captured.

### SUMMARY OF THE INVENTION

According to an aspect of one embodiment of the invention, an example communication-quality measuring apparatus is capable of measuring communication quality in a packet exchange network. The communication-quality measuring apparatus includes the following elements: a connecting section configured to establish a connection to the packet exchange network; a capturing section configured to capture packets transferred over the packet exchange network; an accumulating section configured to accumulate the packets captured by the capturing section; a control section configured to repeat the capturing of packets using the capturing section in units of fundamental processing times, each fundamental processing time including a capturing time for capturing packets and an interval time for not capturing packets; a setting section configured to set the capturing time and the interval time within each fundamental processing time; and a determining section configured to determine whether or not the amount of load on hardware resources of the communication-quality measuring apparatus is greater than a predetermined value. In the case where the determining section determines that the amount of load is greater than the predetermined value, the setting section is configured to increase a ratio of the interval time to the fundamental processing time, and, in the case where the determining section determines that the amount of load is less than or equal to the predetermined value, the setting section is configured to decrease the ratio of the interval time to the fundamental processing time.

According to this aspect of the present invention, the capturing of packets is intermittently repeated on the basis of a capturing time and an interval time set in each fundamental processing time. Not all the packets are captured, and load on hardware resources of the measuring apparatus is reduced. The packets intermittently captured and accumulated are analyzed, thereby measuring the communication quality. Whether or not the amount of load on the hardware resources is greater than a predetermined value is determined. In the case where it is determined that the amount of load is greater than the predetermined value, the ratio of the interval time to the fundamental processing time is reset to a larger ratio until the amount of load that has been determined to be greater than the predetermined value becomes less than or equal to the predetermined value. Accordingly, the load on the quality measuring apparatus is reduced, and the probability of packets being discarded is reduced. In the case where it is determined that the amount of load is less than or equal to the predetermined value, the ratio of the interval time to the fundamental processing time is reset to a smaller ratio.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic diagram of the concept of measuring the quality of an IP phone service in a state where a communication-quality measuring apparatus according to a first embodiment of the present invention is connected to a packet exchange network;

FIG. 2 is a block diagram of the structure of the communication-quality measuring apparatus according to the first embodiment;

FIG. 3 is a functional block diagram of a control section of the communication-quality measuring apparatus according to the first embodiment;

FIG. 4 is a flowchart of a process of capturing packets with a packet capturing section of the control section of the communication-quality measuring apparatus according to the first embodiment;

FIG. 5 is a flowchart of a process of controlling the execution/stopping of capturing packets with a capturing control section of the control section of the communication-quality measuring apparatus according to the first embodiment;

FIG. 6 illustrates the concept of how packets are captured in accordance with the amount of load by allowing the control section of the communication-quality measuring apparatus according to the first embodiment to function as the capturing control section;

FIG. 7 is a flowchart of a process of calculating a packet loss rate with the control section of the communication-quality measuring apparatus according to the first embodiment using the function of a quality analyzing section;

FIGS. 8A to 8C illustrate exemplary quality analysis results displayed on a display section on the basis of outputs from the control section of the communication-quality measuring apparatus according to the first embodiment;

FIG. 9 is a flowchart of a procedure of setting a capturing time Tcap and an interval time Tint in the case where the control section of the communication-quality measuring apparatus according to a second embodiment of the present invention determines that load on hardware resources is heavy; and

FIG. 10 is a flowchart of a procedure of setting the capturing time Tcap and the interval time Tint in the case where the control section of the communication-quality measuring apparatus according to a third embodiment of the present invention determines that load on hardware resources is heavy.

### DESCRIPTION OF THE PREFERRED EMBODIMENTS

Embodiments of the present invention will be specifically described with reference to the drawings.

### First Embodiment

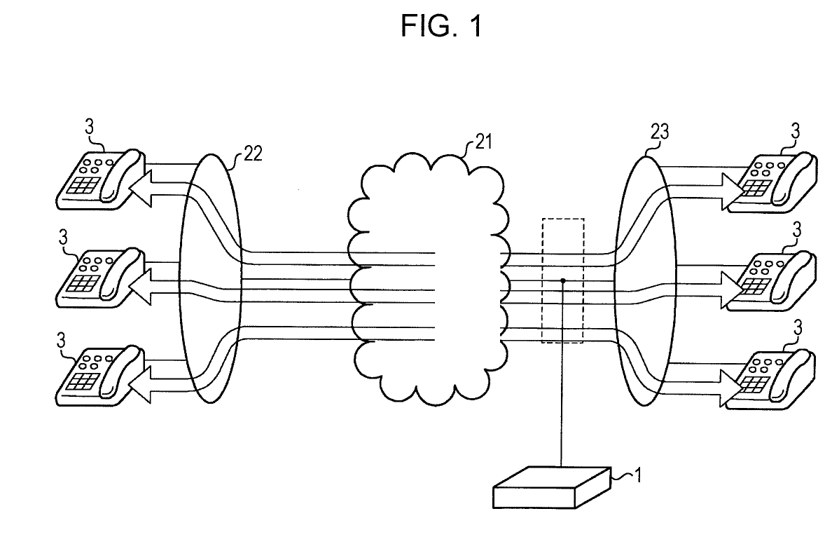

FIG. 1 is a schematic diagram of the concept of measuring the quality of an IP phone service in a state where a communication-quality measuring apparatus according to a first embodiment of the present invention is connected to a packet exchange network. Referring to FIG. 1, a communication-quality measuring apparatus 1 according to the first embodiment is connected via a router (not shown) and a device such as a switching hub (not shown) to a packet exchange network 21 providing the IP phone service. Phones 3 according to the first embodiment have functions of IP phones and are connected to corresponding networks 22 via routers and switching hubs (not shown).

The arrows in FIG. 1 represent the flow of packets conveying voice data. With a Session Initiation Protocol (SIP) server (not shown), a call-connection is established between the phones 3. Using a Realtime Transport Protocol (RTP) session established by the SIP server, packets conveying voice data are transmitted to and received from the phones 3. Accordingly, the IP phone service is realized.

The communication-quality measuring apparatus 1 according to the first embodiment captures packets transmitted to and received from the phones 3 using RTP sessions. The communication-quality measuring apparatus 1 reads and analyzes RTP headers of the packets captured, thereby determining the presence of lost packets or delay of the packets. Accordingly, the quality of the IP phone service over the packet exchange network 21 is measured.

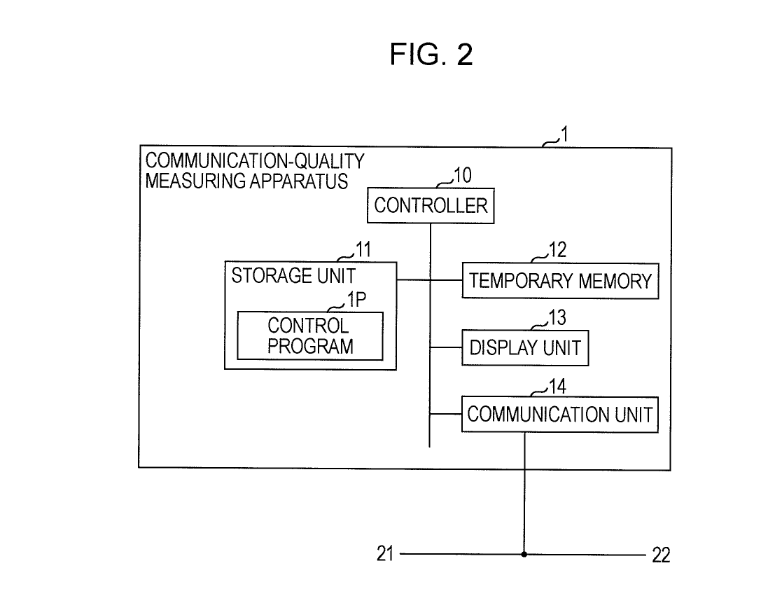

FIG. 2 is a block diagram of the communication-quality measuring apparatus 1 according to the first embodiment of the present invention. The communication-quality measuring apparatus 1 includes a control section 10 controlling the operation of the communication-quality measuring apparatus 1, a storage section 11 such as a hard disk, a temporary memory 12 including a memory such as a random access memory (RAM), a display section 13 including a liquid crystal monitor or the like, and a communication section 14 establishing a connection to the packet exchange network 21.

The storage section 11 stores a control program 1P. The control section 10 loads the control program 1P into the temporary memory 12 and executes the control program 1P. Accordingly, the functions of the communication-quality measuring apparatus 1 are performed. The control program 1P includes a plurality of modules, and the control section 10 performs the plural functions using the corresponding modules. A detailed description will be given later.

The temporary memory 12 stores the control program 1P loaded from the storage section 11 using the control section 10. Further, the temporary memory 12 stores various pieces of information generated in processes performed by executing the control program 1P.

The display section 13 is a user interface that outputs various pieces of information on the basis of outputs from the control section 10. The control section 10 outputs the results of analyzing the captured packets to the display section 13.

The communication section 14 is, for example, a network adapter. The communication section 14 connects to the packet exchange network 21, thereby performing packet exchange. The control section 10 controls the communication section 14 via a driver included in the control program 1P. Accordingly, the control section 10 captures packets from the packet exchange network 21.

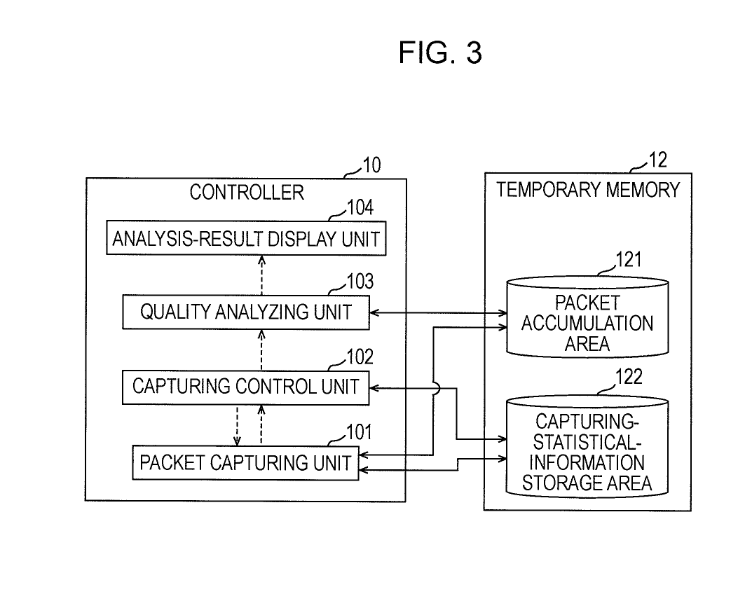

FIG. 3 is a functional block diagram of the control section 10 of the communication-quality measuring apparatus 1 according to the first embodiment. By reading the control program 1P, the control section 10 of the communication-quality measuring apparatus 1 functions as a packet capturing section 101 that captures and accumulates packets via the communication section 14, a capturing control section 102 that controls the execution/stopping of capturing packets with the packet capturing section 101, a quality analyzing section 103 that analyzes loss and delay of the packets by analyzing the packets accumulated by the packet capturing section 101, and an analysis-result display section 104 which is a graphical user interface (GUI) that outputs the results of analyzing loss and delay of the packets, which are obtained by the quality analyzing section 103, to the display section 13.

By functioning as the packet capturing section 101, the control section 10 secures in the temporary memory 12 a packet accumulation area 121 for accumulating packets captured via the communication section 14 and accumulates the packets captured in the packet accumulation area 121.

By functioning as the packet capturing section 101, the control section 10 counts the number of packets captured via the communication section 14 (hereinafter referred to as “the number of captured packets”) and the number of packets that have been captured but could not have been accumulated in the packet accumulation area 121 (hereinafter referred to as “the number of discarded packets”).

Further, the control section 10 stores the counted numbers of captured packets and discarded packets in a capturing-statistical-information storage area 122 secured in the temporary memory 12.

In accordance with an instruction given from the capturing control section 102, the packet capturing section 101 initializes the number of captured packets and the number of discarded packets, which are stored in the capturing-statistical-information storage area 122.

Every time the control section 10 functioning as the packet capturing section 101 captures packets within a predetermined period of time, the packet capturing section 101 sends a notification indicating completion of the capturing to the capturing control section 102.

Every time the control section 10 functioning as the capturing control section 102 receives the notification from the packet capturing section 101, the capturing control section 102 sends a notification of the completion of the capturing to the quality analyzing section 103. Every time the control section 10 functioning as the quality analyzing section 103 receives the notification from the capturing control section 102, the quality analyzing section 103 reads the packets from the packet accumulation area 121 secured in the temporary memory 12 and analyzes the packets.

Under control of the capturing control section 102, the control section 10 functioning as the packet capturing section 101 executes/stops the capturing of packets.

The control section 10 functioning as the capturing control section 102 controls the execution/stopping of capturing packets with the packet capturing section 101 on a predetermined fundamental processing time allocation basis. That is, the control section 10 functioning as the capturing control section 102 repeats the operation of capturing packets with the packet capturing section 101 in units of fundamental processing times, each fundamental processing time including a capturing time for capturing packets and an interval time for not capturing packets.

Therefore, the control section 10 functioning as the packet capturing section 101 repeats a capturing time Tcap for capturing packets and an interval time Tint for stopping the capturing of packets in units of fundamental processing times Tu, thereby intermittently capturing packets.

In this case, the control section 10 functioning as the capturing control section 102 sets the fundamental processing time Tu, the capturing time Tcap, and the interval time Tint so that Tu=Tcap+Tint holds true. Accordingly, the control section 10 functioning as the capturing control section 102 controls the execution/stopping of capturing packets with the packet capturing section 101.

The control section 10 sets Tu in multiples or other units of unit times Td. For example, the control section 10 sets Tu to be ten times Td.

Further, the control section 10 initializes the capturing time Tcap to Tcap=Tu. Therefore, the interval time Tint is initially set to zero.

The temporary memory 12 stores the unit time Td, the fundamental processing time Tu, the capturing time Tcap, and the interval time Tint. The control section 10 refers to the temporary memory 12 for the unit time Td, the fundamental processing time Tu, the capturing time Tcap, and the interval time Tint.

The control section 10 functioning as the quality analyzing section 103 reads the RTP headers from the packets accumulated in the packet accumulation area 121. Each of the RTP headers includes the sequence number in a corresponding RTP session and time information.

Therefore, the control section 10 functioning as the quality analyzing section 103 can determine the presence of lost packets, count the number of lost packets, and calculate a packet loss rate by detecting a gap of sequence number.

The control section 10 functioning as the quality analyzing section 103 can determine the presence of delay by reading the time information.

Further, the control section 10 functions as the analysis-result display section 104. In this case, the control section 10 functioning as the analysis-result display section 104 outputs information (RTP header information) of the packets analyzed using the function of the quality analyzing section 103 to the display section 13. Accordingly, the display section 13 displays the calculated packet loss rate.

Processes performed using the functions of the control section 10 included in the communication-quality measuring apparatus 1 will be described.

In the case where the control section 10 of the communication-quality measuring apparatus 1 functions as the packet capturing section 101, the capturing control section 102, the quality analyzing section 103, and the analysis-result display section 104, the control section 10 performs these functions in terms of threads. That is, the threads performed by the control section 10 notify one another of information, share storage areas, and perform processes in parallel.

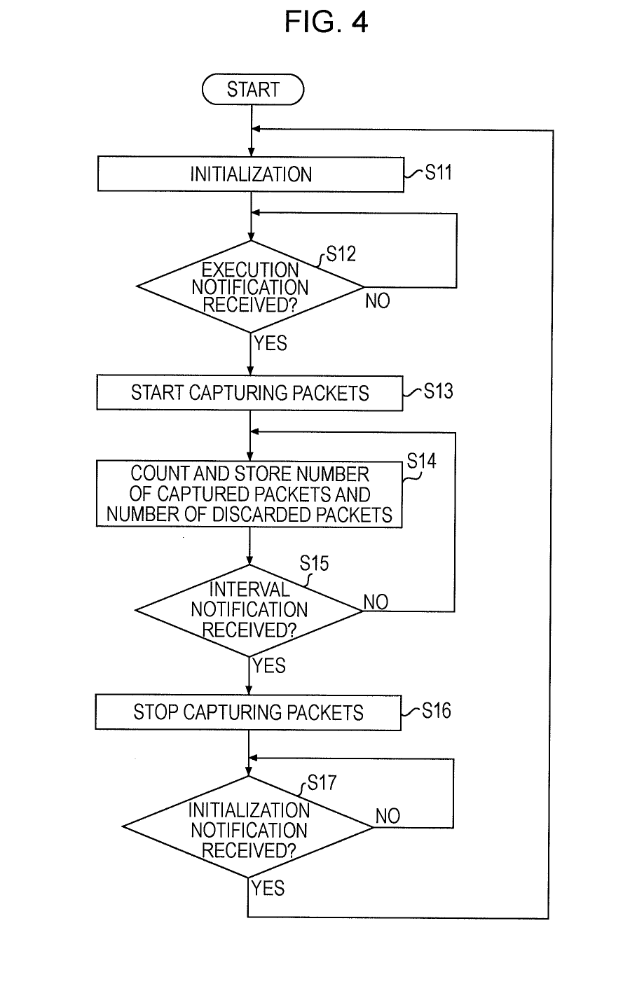

FIG. 4 is a flowchart of a process of capturing packets with the control section 10 included in the communication-quality measuring apparatus 1 and functioning as the packet capturing section 101 according to the first embodiment.

The control section 10 functioning as the packet capturing section 101 initializes the number of captured packets and the number of discarded packets, which are stored in the capturing-statistical-information storage area 122, by substituting zeros for these variables (step S11).

The control section 10 functioning as the packet capturing section 101 determines whether or not a notification of executing the capturing has been received from the capturing control section 102 (step S12).

In the case where the control section 10 functioning as the packet capturing section 101 determines that no notification of executing the capturing has been received (NO in step S12), the flow returns to step S12, and the packet capturing section 101 enters standby until it is determined that a notification of executing the capturing has been received.

In the case where the control section 10 functioning as the packet capturing section 101 determines that a notification of executing the capturing has been received from the capturing control section 102 (YES in step S12), the packet capturing section 101 starts capturing packets via the communication section 14 (step S13) and counts the number of captured packets.

After starting capturing the packets, the control section 10 functioning as the packet capturing section 101 counts the number of captured packets and the number of discarded packets, which are packets that have been captured but could not have been accumulated in the packet accumulation area 121, and stores the counted numbers in the capturing-statistical-information storage area 122 (step S14).

Next, the control section 10 functioning as the packet capturing section 101 determines whether or not an interval notification of stopping the capturing has been received from the capturing control section 102 (step S15). In the case where the control section 10 functioning as the packet capturing section 101 determines that no interval notification has been received (NO in step S15), the flow returns to step S14, and the packet capturing section 101 continues counting and storing the number of captured packets and the number of discarded packets.

In the case where the control section 10 functioning as the packet capturing section 101 determines that an interval notification has been received (YES in step S15), the packet capturing section 101 stops capturing packets via the communication section 14 (step S16).

The control section 10 functioning as the packet capturing section 101 determines whether or not an initialization notification has been received from the capturing control section 102 (step S17).

In the case where the control section 10 functioning as the packet capturing section 101 determines that no initialization notification has been received (NO in step S17), the flow returns to step S17, and the packet capturing section 101 enters standby until it is determined that an initialization notification has been received.

In the case where the control section 10 functioning as the packet capturing section 101 determines that an initialization notification has been received (YES in step S17), the flow returns to step S11, and the packet capturing section 101 initializes the capturing-statistical-information storage area 122 and continues capturing packets.

In the case where the control section 10 functioning as the packet capturing section 101 determines that a termination notification has been received from the outside, or in the case where an error has occurred, the process is terminated.

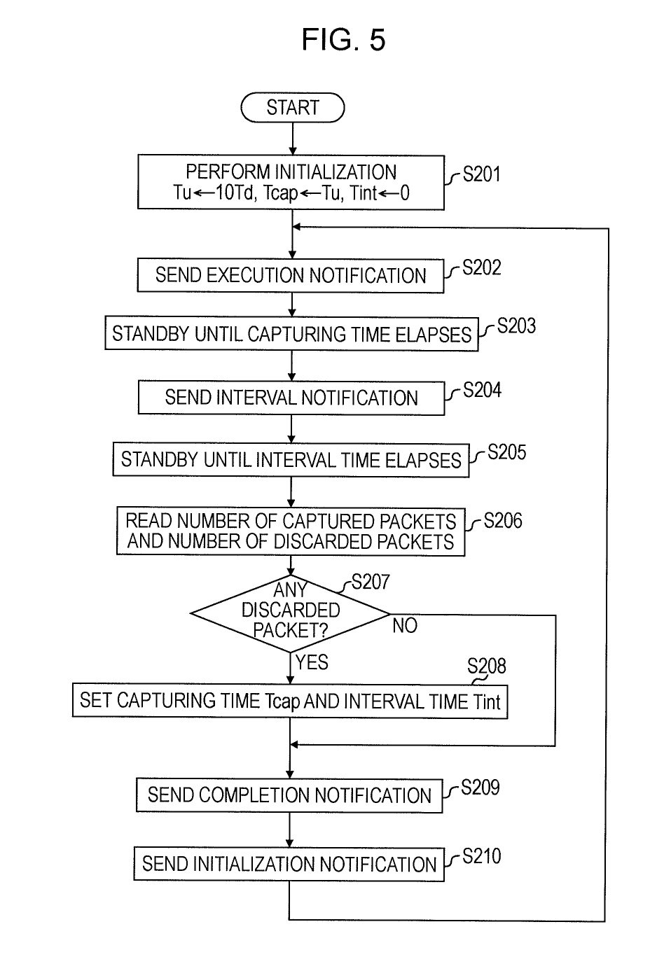

FIG. 5 is a flowchart of a process of controlling the execution/stopping of capturing packets with the control section 10 included in the communication-quality measuring apparatus 1 according to the first embodiment and functioning as the capturing control section 102.

The flowchart shown in FIG. 5 corresponds to a process of sending an execution notification, an interval notification, and an initialization notification for the packet capturing process performed by the control section 10 functioning as the packet capturing section 101 shown in FIG. 4.

The control section 10 functioning as the capturing control section 102 initializes the unit time Td, the fundamental processing time Tu, the capturing time Tcap, and the interval time Tint stored in the temporary memory 12 (step S201). In the first embodiment, the unit time Td is initially set to 100 msec; the fundamental processing time Tu is initially set to 1000 msec, which is ten times the unit time Td; the capturing time Tcap is initially set to Tu; and the interval time Tint is initially set to zero.

Next, the control section 10 functioning as the capturing control section 102 sends an execution notification to the packet capturing section 101 (step S202) and enters standby until the capturing time Tcap elapses (step S203). Accordingly, the control section 10 functioning as the packet capturing section 101 captures packets until the capturing time Tcap elapses.

After the capturing time Tcap has elapsed, the control section 10 functioning as the capturing control section 102 sends an interval notification to the packet capturing section 101 (step S204) and enters standby until the interval time Tint elapses (step S205). Accordingly, the control section 10 functioning as the packet capturing section 101 stops capturing packets until the interval time Tint elapses.

After the interval time Tint has elapsed, the control section 10 functioning as the capturing control section 102 reads the number of captured packets and the number of discarded packets, which are stored in the capturing-statistical-information storage area 122 (step S206).

The control section 10 functioning as the capturing control section 102 determines whether or not a packet(s) has/have been discarded on the basis of the number of captured packets and the number of discarded packets, which are read from the capturing-statistical-information storage area 122 (step S207).

In the case where the control section 10 functioning as the capturing control section 102 determines that a packet(s) has/have been discarded (YES in step S207), the capturing control section 102 determines that the load on hardware resources of the communication-quality measuring apparatus 1 is heavy.

In this case, the control section 10 functioning as the capturing control section 102 sets the interval time Tint and the capturing time Tcap (Tcap=Tu−Tint) such that the ratio of the interval time Tint to the fundamental processing time Tu (the value Tint/Tu) can be increased (step S208).

For example, in step S208, the capturing control section 102 performs the setting to shorten the capturing time Tcap by unit time Td (Tcap<-Tcap−Td) and to elongate the interval time Tint by unit time Td (Tint<-Tint+Td).

In the case where the control section 10 functioning as the capturing control section 102 determines that no packet has been discarded (NO in step S207), the capturing control section 102 does not change the capturing time Tcap and the interval time Tint, and the flow proceeds to step S209.

After the processing in step S208 is completed, or in the case where it is determined by the processing in step S207 that no packet has been discarded (NO in step S207), the control section 10 functioning as the capturing control section 102 sends a completion notification indicating that the capturing of packets has been completed to the quality analyzing section 103 (step S209) and an initialization notification to the packet capturing section 101 (step S210). Thereafter, the flow returns to step S201, and the control section 10 functioning as the capturing control section 102 continues controlling the capturing of packets using the packet capturing section 101.

Note that step S201 may be skipped from the second time onward, and no initialization may necessarily be performed.

In the case where it is determined that a termination notification has been sent from the outside or an error has occurred, the control section 10 functioning as the capturing control section 102 terminates the process.

The process of controlling the execution/stopping of capturing packets with the control section 10 is not limited to that shown in FIG. 5 except for steps S202 to S205.

For example, the notification of completion of capturing packets may be sent to the quality analyzing section 103 after the initialization notification has been sent to the packet capturing section 101. Further, the capturing time Tcap and the interval time Tint may be set by a method involving reading the number of discarded packets, storing whether or not a packet(s) has/have been discarded, and, before sending an execution notification, increasing/decreasing the capturing time Tcap and the interval time Tint in multiples or other units of unit times Td on the basis of the determination whether or not a packet(s) has/have been discarded.

In accordance with the processes shown in the flowcharts of FIGS. 4 and 5, the control section 10 included in the communication-quality measuring apparatus 1 intermittently captures packets via the communication section 14. As a result, if it is determined that a packet(s) has/have been discarded, the control section 10 shortens the capturing time Tcap and elongates the interval time Tint. By elongating the interval time Tint, the load on hardware resources of the communication-quality measuring apparatus 1 is alleviated, and discarding of packets is effectively avoided. That is, the processing performed in the interval time Tint places a lighter load on the hardware resources than that placed by the processing performed in the capturing time Tcap.

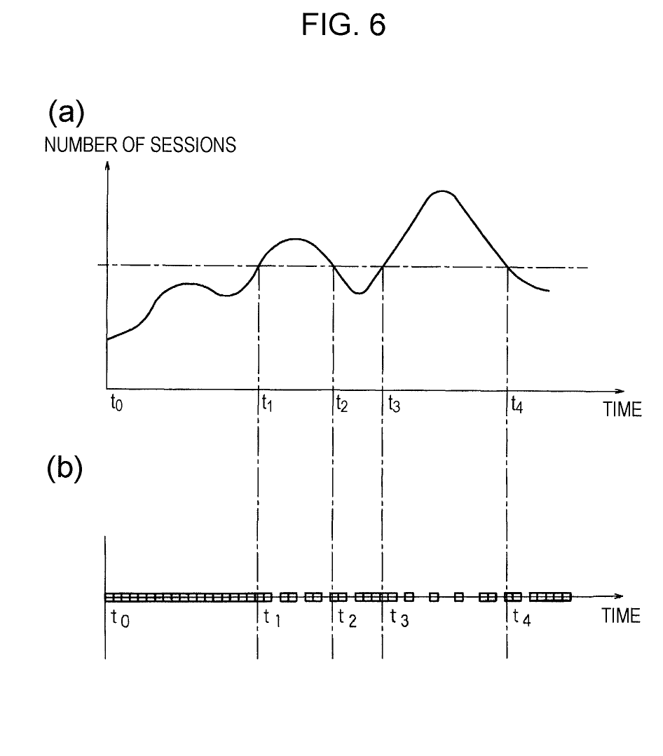

FIG. 6 conceptually illustrates how the packet capturing operation under control of the capturing control section 102 changes according to the amount of load on the communication-quality measuring apparatus 1 according to the first embodiment.

Referring to a graph shown in part (a) of FIG. 6, the axis of abscissa represents elapsed time, and the axis of ordinate represents the number of sessions included in a call (more specifically, the total amount of traffic communicated), which is obtained from packets captured by the communication-quality measuring apparatus 1 via the communication section 14. That is, the graph shown in part (a) of FIG. 6 shows the number of sessions relative to the elapsed time. A horizontal chain line in part (a) of FIG. 6 shows a limit value of the control section 10 included in the communication-quality measuring apparatus 1 regarding the number of sessions in which packets can be captured and analyzed.

In the case where the number of sessions included in a call, which is obtained from packets captured by the communication-quality measuring apparatus 1 via the communication section 14, exceeds this limit, a packet(s) is/are discarded in the packet capturing process performed by the packet capturing section 101 due to the insufficiency of processing capacity.

Referring to part (a) of FIG. 6, the processing capacity is sufficient in time from t0 to t1, in time from t2 to t3, and in time from t4 onward. Therefore, no packet is discarded.

However, the number of sessions exceeds the limit of processing capacity in time from t1 to t2 and in time from t3 to t4. As a result, packets are discarded.

The axis of abscissa in part (b) of FIG. 6 represents elapsed time. The elapsed time represented in abscissa of part (b) of FIG. 6 is in synchronization with the elapsed time represented in abscissa of part (a) of FIG. 6. Rectangles shown in part (b) of FIG. 6 represent that packets are captured at respective times.

In time from t0 to t1 in part (b) of FIG. 6, it is shown that the control section 10 included in the communication-quality measuring apparatus 1 functions as the packet capturing section 101 and captures all the packets via the communication section 14. That is, the capturing time Tcap is equal to the fundamental processing time Tu in time from t0 to t1 in part (b) of FIG. 6. Therefore, the control section 10 functioning as the packet capturing section 101 continues capturing packets in the entirety of the fundamental processing time Tu.

In time from t1 to t2 in part (b) of FIG. 6, it is shown that the control section 10 included in the communication-quality measuring apparatus 1 and functioning as the packet capturing section 101 intermittently captures packets.

In time from t1 to t2 in part (b) of FIG. 6, the number of sessions exceeds the limit of the processing capacity, as shown in part (a) of FIG. 6. Therefore, packets are discarded in the packet capturing process performed by the packet capturing section 101.

Therefore, the control section 10 functioning as the capturing control section 102 determines that the load on the hardware resources of the communication-quality measuring apparatus 1 is heavy (YES in step S207), shortens the capturing time Tcap by reducing the multiples of unit times Td, and elongates the interval time Tint by multiples or other units of unit times Td. Accordingly, a time in which the control section 10 captures no packets is generated.

In time from t2 to t3 in part (b) of FIG. 6, a change in the processing performed by the control section 10 included in the communication-quality measuring apparatus 1 and functioning as the packet capturing section 101 is shown. That is, the packet capturing section 101 intermittently captures packets at first, as in time from t1 to t2, and then starts capturing all the packets. In other words, in time from t2 to t3, the control section 10 intermittently captures packets at first. Since no packet has been discarded, the control section 10 elongates the capturing time Tcap. As a result, the capturing time Tcap again becomes equal to the fundamental processing time Tu.

It is shown that the number of sessions in time from t3 to t4 in part (b) of FIG. 6 further exceeds the limit of the processing capacity, compared with the number of sessions in time from t1 to t2 in part (b) of FIG. 6.

Therefore, the control section 10 included in the communication-quality measuring apparatus 1 and functioning as the capturing control section 102 determines that the load on the hardware resources of the communication-quality measuring apparatus 1 is heavy (YES in step S207), shortens the capturing time Tcap by multiples or other units of unit times Td, and elongates the interval time Tint in units of unit times Td. Accordingly, as in time from t1 to t2, the control section 10 included in the communication-quality measuring apparatus 1 and functioning as the packet capturing section 101 intermittently captures packets.

Since the number of sessions in time from t3 to t4 in part (b) of FIG. 6 further exceeds the limit of the processing capacity than the number of sessions in time from t1 to t2, more packets are discarded.

Therefore, the capturing control section 102 shortens the capturing time Tcap and elongates the interval time Tint further in time from t3 to t4 than in time from t1 to t2 and intermittently captures packets.

That is, although the control section 10 functioning as the capturing control section 102 has shortened the capturing time Tcap so that packets are intermittently captured since it has been determined that packets have been discarded, packets are still discarded in time from t3 to t4. Therefore, the capturing time Tcap is further shortened.

In time from t4 onward shown in FIG. 6, the number of sessions falls below the limit of the processing capacity, as in time from t2 to t3.

Therefore, the control section 10 included in the communication-quality measuring apparatus 1 and functioning as the packet capturing section 101 intermittently captures packets, as in time from t3 to t4, and then captures all the packets.

That is, in time from t4 onward shown in part (b) of FIG. 6, since no packet has been discarded even when the packets have been intermittently captured, the control section 10 functioning as the capturing control section 102 elongates the capturing time Tcap. As a result, it is shown in part (b) of FIG. 6 that the capturing time Tcap again becomes equal to the fundamental processing time Tu.

As shown in FIG. 6, according to the communication-quality measuring apparatus 1 of the first embodiment, packets are captured in accordance with the processing capacity of the apparatus. Therefore, discarding of packets can be avoided. By allowing the control section 10 of the communication-quality measuring apparatus 1 to perform the processes shown in the flowcharts of FIGS. 4 and 5, quality measurement in accordance with the processing capacity of the communication-quality measuring apparatus 1 can be performed.

Next, using the function of the quality analyzing section 103, the control section 10 of the communication-quality measuring apparatus 1 analyzes the packets captured using the function of the packet capturing section 101 and accumulated in the packet accumulation area 121, and outputs information such as a packet loss rate or the like.

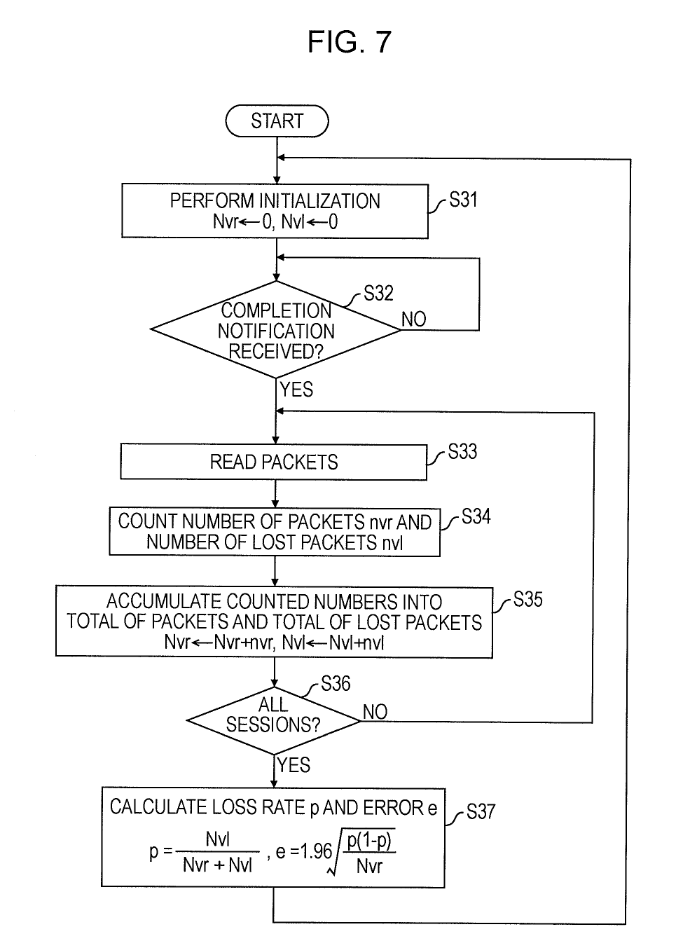

FIG. 7 is a flowchart of a process of calculating a packet loss rate with the control section 10 of the communication-quality measuring apparatus 1 according to the first embodiment using the function of the quality analyzing section 103.

The control section 10 functioning as the quality analyzing section 103 performs initialization setting by substituting zeros for a packet-total counter Nvr indicating the total number of packets transferred over the packet exchange network and a lost-packet-total counter Nvl indicating the total number of packets lost in the packet exchange network (Nvr<-zero and Nvl<-zero) (step S31).

Next, the control section 10 functioning as the quality analyzing section 103 determines whether or not a completion notification indicating completion of the capturing of packets has been received from the capturing control section 102 (step S32).

In the case where the control section 10 functioning as the quality analyzing section 103 determines that no completion notification has been received (NO in step S32), the flow returns to step S32, and the quality analyzing section 103 enters standby until it is determined that a completion notification has been received.

In contrast, in the case where the control section 10 functioning as the quality analyzing section 103 determines that a completion notification has been received (YES in step S32), the quality analyzing section 103 reads packets from the packet accumulation area 121 in units of RTP sessions (step S33) and counts the number of packets nvr and the number of lost packets nvl (step S34).

That is, the control section 10 functioning as the quality analyzing section 103 reads packets from the packet accumulation area 121 in units of RTP sessions, counts the number of packets by reading the sequence numbers that should be continuous from the RTP headers of the packets read, and counts the number of lost packets by detecting a gap in the sequence numbers that should be continuous.

The control section 10 functioning as the quality analyzing section 103 accumulates the number of packets nvr and the number of lost packets nvl counted in units of RTP sessions into the packet-total counter Nvr and the lost-packet-total counter Nvl (step S35).

The control section 10 functioning as the quality analyzing section 103 determines whether or not packets of all the sessions corresponding to the packets accumulated in the packet accumulation area 121 have been read (step S36).

In the case where the control section 10 functioning as the quality analyzing section 103 determines that packets of all the sessions have not been read (NO in step S36), the flow returns to step S33, and the quality analyzing section 103 repeats the operation of reading packets of the next RTP session, counting the number of packets nvr and the number of lost packets nvl, and accumulating these numbers into the corresponding counters Nvr and Nvl.

In contrast, in the case where the control section 10 functioning as the quality analyzing section 103 determines that packets of all the sessions have been read (YES in step S36), the quality analyzing section 103 calculates a loss rate p and an error e on the basis of the accumulated packet-total counter Nvr and the lost-packet-total counter Nvl (step S37).

The loss rate p in step S37 can be calculated using the following equation (1).

The loss rate p calculated by the control section 10 in step S37 is the loss rate with reference to the number of all the packets captured within the capturing time Tcap in each fundamental processing time Tu.

That is, every time the fundamental processing time Tu elapses, the quality analyzing section 103 calculates the loss rate p within that fundamental processing time Tu.

The quality analyzing section 103 can calculate the error e using, for example, the following equation (2) on the basis of a general method of calculating a statistical error in the case where samples (packets captured intermittently) are extracted from a population (all the packets).

$$\begin{matrix}p = \frac{Nvl}{Nvr + Nvl} & ( 1 ) \\ e = 1.96 \sqrt{\frac{p ( 1 - p )}{Nvr}} & ( 2 )\end{matrix}$$

After the control section 10 functioning as the quality analyzing section 103 has calculated the loss rate p and the error e, the flow returns to step S31, and the quality analyzing section 103 calculates the loss rate p within the next fundamental processing time Tu.

In the first embodiment, the example in which the loss rate p is calculated in units of fundamental processing times Tu has been described. Alternatively, however, the loss rate in a plurality of cycles may be calculated.

Next, the control section 10 functioning as the quality analyzing section 103 outputs the calculated loss rate p and the error e in the loss rate p in association with each other to the display section 13.

The display section 13 displays the loss rate p and the error e output from the control section 10.

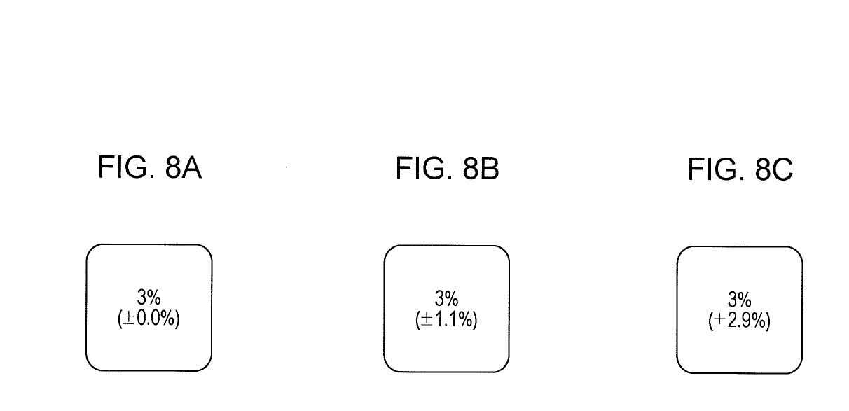

FIGS. 8A to 8C illustrate exemplary quality analysis results displayed on the display section 13 on the basis of outputs from the control section 10 included in the communication-quality measuring apparatus 1 according to the first embodiment and functioning as the quality analyzing section 103.

FIGS. 8A to 8C illustrate exemplary screens displaying the packet loss rate p using the control section 10 included in the communication-quality measuring apparatus 1 and functioning as the analysis-result display section 104.

The control section 10 functioning as the analysis-result display section 104 displays, besides the loss rate p, the error e in the loss rate p in parentheses on the display section 13.

FIG. 8A illustrates the case in which the packet capturing time Tcap is equal to the fundamental processing time Tu and all the packets are captured. FIG. 8B illustrates the case where the interval time Tint in which the capturing of packets is stopped is not zero. FIG. 8C illustrates the case in which the interval time Tint is further elongated.

The display examples illustrated in FIGS. 8A to 8C correspond to part (b) of FIG. 6 illustrating changes in timing of capturing packets with reference to the elapsed time.

More specifically, FIG. 8A illustrates the example in which the loss rate p in time from t0 to t1 of part (b) of FIG. 6 is displayed. FIG. 8B illustrates the example in which the loss rate p in time from t1 to t2 of part (b) of FIG. 6 is displayed. FIG. 8C illustrates the example in which the loss rate p in time from t3 to t4 of part (b) of FIG. 6 is displayed. Since the packet capturing time Tcap is the shortest in time from t3 to t4, the number of packets counted becomes also smaller, and the counting error calculated using equation (1) becomes larger.

The loss rate p and the error e in the loss rate p are displayed on the screen of the display section 13, as illustrated in FIGS. 8A to 8C, using the control section 10 included in the communication-quality measuring apparatus 1 according to the first embodiment and functioning as the analysis-result display section 104.

Visibly recognizing that the value of the error e is not zero, the user determines that the capturing of packets is intermittently performed due to the insufficiency in the processing capacity. Further, the user can be informed of the error in the loss rate p by visibly recognizing the value of the error e. Therefore, the reliability of the value of the loss rate p becomes higher.

### Second Embodiment

In the first embodiment, in the case where the control section 10 included in the communication-quality measuring apparatus 1 and functioning as the capturing control section 102 determines that a packet(s) has/have been discarded in the packet capturing process, the capturing control section 102 shortens the capturing time Tcap within the fundamental processing time Tu in multiples or other units of unit times Td and elongates the interval time Tint in units of unit times Td.

In contrast, according to a second embodiment of the present invention described below, the control section 10 included in the communication-quality measuring apparatus 1 and functioning as the capturing control section 102 calculates the number of bytes of voice data received in the fundamental processing time Tu on the basis of the number of packets captured in the fundamental processing time Tu and the packet length.

In the case where the control section 10 functioning as the capturing control section 102 determines that a packet(s) has/have been discarded in the packet capturing process, the capturing control section 102 sets the capturing time Tcap so that the calculated number of received bytes becomes closer to a predetermined value.

Since the hardware configuration of the communication-quality measuring apparatus 1 according to the second embodiment is similar to that of the first embodiment, a detailed description thereof is omitted.

In the second embodiment, the process of setting the capturing time Tcap and the interval time Tint using the control section 10 included in the communication-quality measuring apparatus 1 and functioning as the capturing control section 102 is different from that in the first embodiment.

The process of setting the capturing time Tcap and the interval time Tint in the second embodiment will now be described using the same reference numerals as those in the first embodiment.

Of the process of controlling the execution/stopping of capturing packets according to the first embodiment, which is shown in FIG. 5, the capturing control section 102 in the second embodiment replaces the processing in step S208 with a procedure described below.

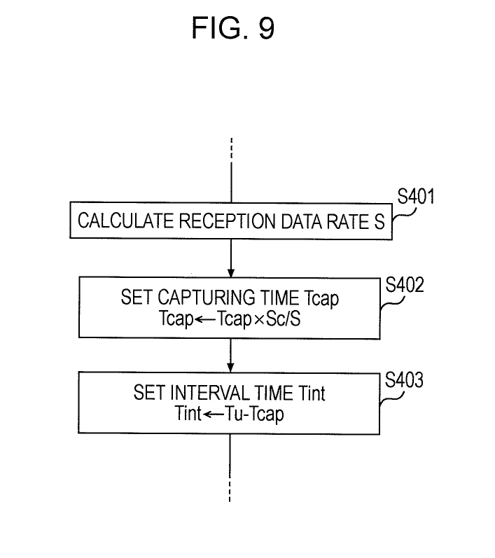

FIG. 9 is a flowchart of a procedure of setting the capturing time Tcap and the interval time Tint in the case where the control section 10 included in the communication-quality measuring apparatus 1 according to the second embodiment determines that the load on the hardware resources is heavy.

The control section 10 included in the communication-quality measuring apparatus 1 and functioning as the capturing control section 102 calculates the amount of data V received via the communication section 14 in the fundamental processing time Tu on the basis of the number of captured packets read and the packet length (bytes).

Further, the capturing control section 102 calculates a reception data rate S by dividing the calculated amount of data V by the fundamental processing time Tu (step S401).

Next, the control section 10 functioning as the capturing control section 102 multiples a value (ratio) that is obtained by dividing a predetermined value Sc by the reception data rate S by the capturing time Tcap that has been set up to that time, thereby setting a new capturing time Tcap (Tcap<-Tcap*Sc/S) (step S402).

Note that, if the calculated capturing time Tcap is larger than the fundamental processing time Tu, the capturing control section 102 sets the capturing time Tcap to the same value as the fundamental processing time Tu (Tcap<-Tu).

Next, the control section 10 functioning as the capturing control section 102 sets the interval time Tint to the difference between the new capturing time Tcap set in step S402 and the fundamental processing time Tu (Tint<-Tu-Tcap) (step S403).

The reason the control section 10 of the communication-quality measuring apparatus 1 according to the second embodiment sets the capturing time Tcap as in the processing in step S402 will be described below.

The processing capacity of the communication-quality measuring apparatus 1 can also be represented in terms of the amount of data that can be received via the communication section 14 per unit time (e.g., one second), that is, the reception data rate S.

If the reception data rate S is close to the predetermined value Sc, the control section 10 is fully capable of capturing packets and analyzing accumulated packets.

According to the second embodiment, in order to maintain the reception data rate S in the capturing time Tcap that has been set up to a certain point close to the predetermined value Sc, the new capturing time Tcap is set by multiplying the ratio of the predetermined value Sc to the reception data rate S up to the certain point by the capturing time Tcap up to the certain point.

As shown in the flowchart of FIG. 9, the communication-quality measuring apparatus 1 according to the second embodiment enables convergence of the reception data rate of packets captured using the control section 10 via the communication section 14 to an optimal reception data rate by setting the capturing time Tcap and the interval time Tint on the basis of the amount of data V received via the communication section 14 in the fundamental processing time Tu.

Accordingly, the communication-quality measuring apparatus 1 according to the second embodiment can perform quality measurement in accordance with its processing capacity.

### Third Embodiment

In the first embodiment, in the case where the control section 10 included in the communication-quality measuring apparatus 1 and functioning as the capturing control section 102 determines that a packet(s) has/have been discarded in the packet capturing process performed by the packet capturing section 101, the capturing control section 102 shortens the capturing time Tcap for capturing packets in the fundamental processing time Tu in units of unit times Td and elongates the interval time Tint in units of unit times Td.

In the second embodiment, the control section 10 included in the communication-quality measuring apparatus 1 and functioning as the capturing control section 102 sets the capturing time Tcap so that the reception data rate converges to a predetermined rate.

In contrast, according to a third embodiment of the present invention described below, in the case where the control section 10 included in the communication-quality measuring apparatus 1 and functioning as the capturing control section 102 determines that a packet(s) has/have been discarded in the packet capturing process performed by the packet capturing section 101, the capturing control section 102 sets the capturing time Tcap so that the utilization of the hardware resources in the fundamental processing time Tu becomes closer to a predetermined value.

Since the hardware configuration of the communication-quality measuring apparatus 1 according to the third embodiment is similar to that of the first embodiment, a detailed description thereof is omitted.

In the third embodiment, the process of setting the capturing time Tcap and the interval time Tint using the control section 10 included in the communication-quality measuring apparatus 1 and functioning as the capturing control section 102 is different from that in the first embodiment.

The process of setting the capturing time Tcap and the interval time Tint according to the third embodiment will now be described using the same reference numbers as those in the first and second embodiments.

Of the process of controlling the execution/stopping of capturing packets according to the first embodiment, which is shown in FIG. 5, the capturing control section 102 in the third embodiment replaces the processing in step S208 with a procedure described below.

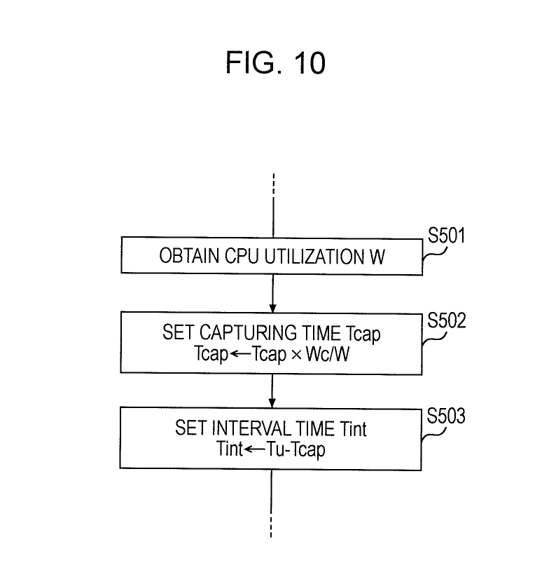

FIG. 10 is a flowchart of a procedure of setting the capturing time Tcap and the interval time Tint in the case where the control section 10 included in the communication-quality measuring apparatus 1 according to the third embodiment determines that the load on the hardware resources is heavy.

The control section 10 included in the communication-quality measuring apparatus 1 and functioning as the capturing control section 102 obtains a central processing section (CPU) utilization W serving as the utilization of the hardware resources (step S501).

Next, the control section 10 functioning as the capturing control section 102 multiplies a value (ratio) obtained by dividing a predetermined value Wc by the obtained “CPU utilization W” by the capturing time Tcap that has been set up to that time, thereby setting the product as a new capturing time Tcap (Tcap<-Tcap*Wc/W) (step S502).

Note that, if the calculated capturing time Tcap is larger than the fundamental processing time Tu, the capturing control section 102 sets the capturing time Tcap to the same value as the fundamental processing time Tu (Tcap<-Tu).

Next, the control section 10 functioning as the capturing control section 102 sets the interval time Tint to the difference between the new capturing time Tcap set in step S502 and the fundamental processing time Tu (Tint<-Tu-Tcap) (step S503).

The reason the control section 10 of the communication-quality measuring apparatus 1 according to the third embodiment sets the capturing time Tcap as in the processing in step S502 will be described below.

The processing capacity of the communication-quality measuring apparatus 1 can also be represented in terms of the CPU utilization of the measuring apparatus currently capturing packets and analyzing the quality.

If the CPU utilization W is close to the predetermined value Wc, the control section 10 is fully capable of capturing packets and analyzing accumulated packets.

According to the third embodiment, in order to maintain the CPU utilization W in the capturing time Tcap that has been set up to a certain point close to the predetermined value Wc, the new capturing time Tcap is set by multiplying the ratio of the predetermined value Wc to the CPU utilization W up to the certain point by the capturing time Tcap up to the certain point.

As shown in the flowchart of FIG. 10, the communication-quality measuring apparatus 1 according to the third embodiment enables convergence of the CPU utilization to an optimal CPU utilization by setting the capturing time Tcap and the interval time Tint on the basis of the CPU utilization W obtained as the utilization of the hardware resources.

Accordingly, the communication-quality measuring apparatus 1 according to the third embodiment can perform quality measurement in accordance with its processing capacity.

In the first to third embodiments, the control section 10 included in the communication-quality measuring apparatus 1 and functioning as the capturing control section 102 determines whether or not a packet(s) has/have been discarded in the packet capturing process performed by the packet capturing section 101, thereby determining whether or not the amount of load on the hardware resources is larger than a predetermined value indicating a limit value.

However, the present invention is not limited to the foregoing embodiments, and the control section 10 functioning as the capturing control section 102 may obtain the CPU utilization or the utilization of the hardware resources of the communication-quality measuring apparatus 1, such as the amount of memory used, and determine whether or not the obtained utilization is larger than a predetermined value that has been set as the limit value.

Alternatively, the control section 10 functioning as the capturing control section 102 may calculate the number of bytes received per second, for example, on the basis of the number of packets captured in the fundamental processing time Tu and the packet length, and determine whether or not the number of bytes received per second exceeds a predetermined value that has been set as the processing limit value.

In any of the foregoing cases, if the utilization or the number of bytes received exceeds the corresponding predetermined value that has been set as the limit value, it can be determined that the amount of load on the hardware resources exceeds the processing capacity.

In the first to third embodiments, the example in which the control section 10 of the communication-quality measuring apparatus 1 calculates the error e in the packet loss rate p using equation (2) has been described.

However, the method of calculating the error e in the loss rate p is not limited to equation (2).

For example, for the number of packets nvr and the number of lost packets nvl counted in units of RTP sessions, if a packet(s) has/have been discarded by the packet capturing section 101, the discarded packet(s) is/are counted as a packet(s) lost in the packet exchange network. The number of packets nvr counted in units of RTP sessions is accumulated into the packet-total counter Nvr.

Therefore, the number of packets nvr and the number of lost packets nvl counted as above can be regarded as lacking in accuracy according to the ratio of the number of discarded packets to the sum of the number of packets and the number of discarded packets.

An error in the number of captured packets may be calculated on the basis of the number of captured packets and the number of discarded packets counted by the packet capturing section 101, and an error e′ in a loss rate p taking into consideration the error in the number of captured packets may be calculated.

In the first to third embodiments, the control section 10 included in the communication-quality measuring apparatus 1 performs the process of initializing the number of captured packets and the number of discarded packets using the packet capturing section 101 and the process of setting the capturing time and the interval time using the capturing control section 102 every time the fundamental processing time Tu elapses.

However, the first to third embodiments according to the present invention are not limited to the foregoing case.

That is, initialization of the number of captured packets and the number of discarded packets using the control section 10 included in the communication-quality measuring apparatus 1 and functioning as the packet capturing section 101 may not be performed until an initialization notification is received from the capturing control section 102 after the execution/stopping of capturing is repeated a few times in the course of a few cycles.

In this case, the control section 10 functioning as the capturing control section 102 determines whether or not a packet(s) has/have been discarded on the basis of the number of captured packets and the number of discarded packets within a few cycles and sets the capturing time and the interval time.

That is, instead of setting the capturing time and the interval time every time, the amount of load placed on the hardware resources may be determined in units of predetermined times serving as a few cycles of the fundamental processing time Tu.

In the first to third embodiments, the communication-quality measuring apparatus 1 includes the display section 13, and the control section 10 outputs an image of the packet loss rate and the error to the display section 13.

However, the first to third embodiments according to the present invention are not limited to the foregoing case.

That is, the communication-quality measuring apparatus 1 may not necessarily include the display section 13.

For example, in the case where the communication-quality measuring apparatus 1 is connected via a communication line to another information processing apparatus, such as a personal computer (PC) or the like, the PC or the like connected to the communication-quality measuring apparatus 1 may obtain information regarding the packet loss rate and the error output from the control section 10 of the communication-quality measuring apparatus 1 and display the obtained packet loss rate and the error on a liquid crystal monitor or the like connected to the PC or the like.

In this case, the user can request the communication-quality measuring apparatus 1 to start measuring the quality by entering a command through a text input interface of the information processing apparatus.

Upon receipt of the request to start measuring the quality, the control section 10 included in the communication-quality measuring apparatus 1 captures packets, counts the number of packets, calculates a packet loss rate and an error, and outputs the packet loss rate and the error to the information processing apparatus in accordance with the processes shown in the flowcharts of FIGS. 4, 5, and 7.

What is claimed is:

1. A communication-quality measuring apparatus configured to measure communication quality in a packet exchange network, comprising:
a connecting section establishing a connection to the packet exchange network;
a capturing section capturing packets transferred over the packet exchange network;
an accumulating section accumulating the packets captured by the capturing section;
a control section repeating the capturing of packets using the capturing section in sections of fundamental processing times, each fundamental processing time including a capturing time for capturing packets and an interval time for not capturing packets;
a setting section setting the capturing time and the interval time within each fundamental processing time; and
a determining section determining whether or not the amount of load on hardware resources of the communication-quality measuring apparatus is greater than a predetermined value,
wherein, in the case where the determining section determines that the amount of load is greater than the predetermined value, the setting section increases a ratio of the interval time to the fundamental processing time, and
wherein, in the case where the determining section determines that the amount of load is less than or equal to the predetermined value, the setting section decreases the ratio of the interval time to the fundamental processing time.

2. The communication-quality measuring apparatus according to claim 1, further comprising a detecting section configured to detect, among the packets captured by the capturing section, any discarded packet that has not been accumulated,
wherein the determining section determines that the amount of load on the hardware resources is greater than the predetermined value in the case where a discarded packet is detected.

3. The communication-quality measuring apparatus according to claim 1 or 2, further comprising:
a first calculating section calculating the amount of data captured per predetermined unit time on the basis of the number of packets captured by the capturing section and a packet length; and
a first determining section determining whether or not the amount of data calculated by the first calculating section is greater than or equal to a predetermined amount,
wherein the determining section determines that the amount of load on the hardware resources is greater than the predetermined value in the case where the first determining section determines that the amount of data is greater than or equal to the predetermined amount.

4. The communication-quality measuring apparatus according to claims 1 or 2, further comprising:
a first utilization obtaining section configured to obtain a utilization of the hardware resources of the communication-quality measuring apparatus; and
a second determining section determining whether or not the utilization obtained by the first utilization obtaining section is greater than or equal to a predetermined utilization,
wherein the determining section determines that the amount of load on the hardware resources is greater than the predetermined value in the case where the second determining section determines that the utilization is greater than or equal to the predetermined utilization.

5. The communication-quality measuring apparatus according to claim 1,
wherein the capturing time and the interval time are set in units of unit times obtained by dividing the fundamental processing time into equal parts,
wherein, in the case where the determining section determines that the amount of load is greater than the predetermined value, the setting section shortens the capturing time by a period in units of unit times and to elongate the interval time by the same period as the shortened period of the capturing time in units of unit times, and
wherein, in the case where the determining section determines that the amount of load is less than or equal to the predetermined value, the setting section elongates the capturing time by a period in units of unit times and to shorten the interval time by the same period as the elongated period of the capturing time in units of unit times.

6. The communication-quality measuring apparatus according to claim 1, further comprising:
a second calculating section calculating the amount of packets captured by the capturing section per predetermined unit time; and
a third calculating section calculating a ratio of a predetermined value to the captured amount calculated by the second calculating section,
wherein the capturing time with reference to the fundamental processing time is set by changing the capturing time to a period obtained by multiplying the capturing time by the ratio.

7. The communication-quality measuring apparatus according to claim 1, further comprising:
a second utilization obtaining section obtaining a utilization of the hardware resources within a predetermined period; and
a fourth calculating section calculating a ratio of a predetermined value to the utilization obtained by the second utilization obtaining section,
wherein the capturing time with reference to the fundamental processing time is set by changing the capturing time to a period obtained by multiplying the capturing time by the ratio.

8. The communication-quality measuring apparatus according to claim 1, further comprising:
a packet counting section counting the number of packets captured by the capturing section and the number of lost packets,
a fifth calculating section calculating a packet loss rate and an error in the packet loss rate on the basis of the number of captured packets and the number of lost packets, which are counted by the packet counting section; and
an output section outputting the packet loss rate and the error in association with each other, the packet loss rate and the error being calculated by the fifth calculating section.

9. The communication-quality measuring apparatus according to claim 1, further comprising:
a discarded-packet counting section counting the number of discarded packets that are packets that have been captured by the capturing section and have not been accumulated in the accumulating section;
a sixth calculating section calculating an error in the number of captured packets on the basis of the number of discarded packets counted by the discarded-packet counting section; and
a seventh calculating section calculating an error in the packet loss rate on the basis of the error in the number of captured packets, which is calculated by the sixth calculating section.

10. A communication-quality measuring method of measuring and adjusting, using a capturing section repeatedly capturing packets transferred over a packet exchange network in units of predetermined fundamental processing times and an accumulating section accumulating the packets captured, communication quality in the packet exchange network by analyzing the packets accumulated, comprising:
setting a capturing time for capturing packets with the capturing section and an interval time for not capturing packets in each fundamental processing time;
determining whether or not the amount of load on hardware resources in the set capturing time and the set interval time is greater than a predetermined value;
resetting, in the case where it is determined that the amount of load is greater than the predetermined value, the length of at least one of the capturing time and the interval time so that a ratio of the interval time to the fundamental processing time becomes larger; and
resetting, in the case where it is determined that the amount of load is less than or equal to the predetermined value, the length of at least one of the capturing time and the interval time so that the ratio of the interval time to the fundamental processing time becomes smaller.

11. A computer-readable recording medium recording a computer program allowing a computer connected to a packet exchange network to function as an apparatus for measuring and adjusting communication quality in the packet exchange network by allowing the computer to function as a capturing section configured to repeatedly capture packets transferred over the packet exchange network in units of fundamental processing times and an accumulating section configured to accumulate the packets captured, the computer program allowing the computer to function as:
a setting section setting a capturing time for capturing packets and an interval time for not capturing packets in each fundamental processing time; and
a determining section determining whether or not the amount of load on hardware resources of the computer is greater than a predetermined value,
wherein, in the case where the determining section determines that the amount of load is greater than the predetermined value, the setting section sets a ratio of the interval time to the fundamental processing time to a larger ratio, and,
wherein, in the case where the determining section determines that the amount of load is less than or equal to the predetermined value, the setting section sets the ratio of the interval time to the fundamental processing time to a smaller ratio.
